(19) United States
(12) Patent Application Publication
(10) Pub. No.: US 2016/0323416 A1
(43) Pub. Date: Nov. 3, 2016

(54) METHOD AND DEVICE FOR UPDATING SOFTWARE IN A MEANS OF TRANSPORTATION

(71) Applicant: Robert Bosch GmbH, Stuttgart (DE)

(72) Inventor: Marko Wolf, Muenchen (DE)

(21) Appl. No.: 15/096,948

(22) Filed: Apr. 12, 2016

(30) Foreign Application Priority Data
Apr. 28, 2015 (DE) 102015207795.0

(51) Int. Cl. H04L 29/08; G06F 9/445; G06F 11/14

(52) U.S. Cl. CPC H04L 67/34; G06F 11/1464; G06F 8/67; H04L 67/10; H04L 67/12

(57) ABSTRACT

To implement an update of the software of a computer device, especially a closed-loop and/or open-loop control device, situated in a means of transportation, such as a motor vehicle, it is proposed to store, prior to starting the update, an image of the software located on the computer device in a data memory which is able to be connected to the computer device via a communications system, to load an updated software onto the computer device, to check whether the update has been successful, and if this is not the case, to transmit at least a portion of the image stored in the data memory to the computer device and to restore it there.

### CROSS REFERENCE

The present application claims the benefit under 35 U.S.C. §119 of German Patent Application No. 102015207795.0 filed on Apr. 28, 2015, which is expressly incorporated herein by reference in this entirety.

### FIELD

The present invention relates to a method for updating the software of a computer device situated inside a transportation device, in particular a motor vehicle, in particular a closed-loop and/or open-loop control device.

The present invention furthermore relates to a device for updating software on at least one computer device in a transportation device. In addition, the present invention relates to a computer device in a transportation device, in particular an open-loop and/or closed-loop control device in a motor vehicle, and a computer program which is executed on an aforementioned computer device.

### BACKGROUND INFORMATION

A multitude of functions in motor vehicles and also in airplanes and ships is controlled by computer devices, such as open-loop and/or closed-loop control devices; these devices are also referred to as controllers, depending on the individual development and the field in which they are used, and/or may also be developed as embedded systems. Many of these computer devices are programmed in software for executing the particular task. Even if the transportation device, that is to say, the motor vehicle, for instance, has already reached the customer and is being operated already, the functions of the computer devices are frequently improved and expanded, or errors are corrected. In these cases the software on the computer device is updated. This means that at least a portion of the software installed on the computer device is replaced by an updated version. In some systems the entire operating software is overwritten during each update. This may possibly also affect data that were collected during the operation of the computer device and which are utilized for adapting the computer device to specific operating conditions, for example.

To have operating data available even after a software update, it is conventional to secure some of these data during the operation of a motor vehicle at predefined intervals or at predefined instants in the form of what is known as a backup. Such a system is described in U.S. Patent Application Publication No. US 2007/0283110, for example. There, the data required for and during the engine operation are transmitted via a data bus available inside the vehicle to the other control devices and stored there. If one control device malfunctions, the operational data stored there may be requested by one of the other control devices and, once the defective control device has been replaced, it can be stored there again for the further operation.

U.S. Pat. No. 6,230,082 describes transmitting data specific to a vehicle to a backup system where the data specific for a particular vehicle are stored. The backup system described there is able to be reached from the vehicle via an internet connection.

U.S. Pat. No. 8,219,279 B2 describes a method in which special parameters and register contents of a controller situated in a vehicle are stored at predefined intervals in the memory of another controller, and in the event that the first controller malfunctions or must be restarted, these data are able to be loaded again from the second controller.

### SUMMARY

It is an object of the present invention to make the execution of the software update, on a computer device in a transportation device, such as a control device for controlling a function in a motor vehicle, more secure. In particular, even if an update is interrupted or is unable to be carried out successfully so that the software on the control device is completely or partially no longer usable, a possibility is to be provided for obtaining an operative state of the control device nevertheless.

The objective is achieved by a method of the type mentioned in the introduction, in that, prior to the update, an image of the software located on the computer device is stored in a data memory that is connectable to the computer device via a communications system, updated software is loaded onto the computer device, and it is checked whether the update was successful; if this is not the case, at least a portion of the image stored in the data memory is transmitted to the computer device and restored there again.

The example method of the present invention therefore makes it possible to store, directly prior to a scheduled software update of a control device, the entire content of the control device, i.e., in particular the software installed there, but if necessary also the data required for operating the software in a data memory situated inside the vehicle.

In a great number of control devices the existing software is directly overwritten in the software update. If the software update is unable to be carried out successfully, for instance because of a fault in the updated software or because a transmission medium quits or for some other reason, then this may result in a control device that can no longer be activated. Another update attempt will then be required However, this is sometimes not possible, especially if, for example, the medium from which the updated software is read, is defective. In such cases it is advantageous if, as proposed, the software and possibly also data which were stored as image (software image) in a data memory situated inside the vehicle and provided for this purpose, can be copied back into the control device to be updated. As a result, the previous state is able to be restored, and an operation of the control device is therefore ensured.

The data memory in particular may be a database server, known as network attached storage (NAS). Such data memories may be developed in software or hardware. Preferably, not only the original version of the software to be updated is stored in the data memory, but the data required for the operation of the control device are stored as well. These data may also include data that were collected for adapting the device to the current operating conditions.

According to one possible specific embodiment, if the update was not successful, at least one further attempt is made to load the updated software onto the computer device. If merely a transmission error has existed, then the update need not be aborted completely or postponed to a later point in time, but in many cases the update can still be successfully completed by starting a new attempt.

According to one advantageous further refinement of the method, the image of the software on the computer device is transmitted via a wireless connection to a data memory situated outside the means of transportation. In particular, it may be provided to transmit the image to the manufacturer of the control device, the software or the vehicle manufacturer via a mobile radio connection. This makes it possible to restore the original state of a control device to be updated even if the data memory located inside the vehicle is defective. It is furthermore possible to store the history of the implemented updates. By collecting the software images, the manufacturers of the software or the control devices may gain information about the types of errors that occurred in a specific version of a particular software. The history may then be used for detecting or restricting subsequent errors, as well.

Preferably, multiple computer devices provided in the transportation device are able to be connected to the data memory in case of an update of the particular software, so that the data memory is available for storing the image of multiple control devices.

The objective may also be achieved by a device of the type mentioned in the introduction, in that the device includes the following:
A data memory which can be connected to the computer device via a communications system;
Means for creating an image of software provided on the at least one computer device;
Means for transmitting the image to the data memory;
Means for loading an updated software onto the at least one computer device;
Check means for checking whether the update has been successful; and
Means for transmitting the image stored in the data memory to the at least one computer device and to restore it there again in the event that the update of the software has been unsuccessful.

Such a device is set up for executing the method of the present invention, so that the same advantages as those achievable by the afore-described method are obtained by this device.

Furthermore, the objective may be achieved by, for example, a computer device of the type mentioned above, in that the computer device is set up for executing the method of the present invention. The objective may moreover be achieved by a computer program which is programmed to execute the example device of the present invention.

Further features, possible applications and advantages of the present invention result from the following description of exemplary embodiments which are explained with the aid of the figures. The features may be important for the invention both on their own and in different combinations without any explicit reference being necessary in this regard.

### BRIEF DESCRIPTION OF THE DRAWINGS

FIG. 1 shows a schematic illustration of the components of an example device developed according to the present invention.

FIG. 2 shows a flow chart of the example method of the present invention.

FIG. 3 shows a schematic illustration of the integration of the example method into the example components of a device developed for executing the method according to one possible specific embodiment.

### DETAILED DESCRIPTION OF EXAMPLE EMBODIMENTS

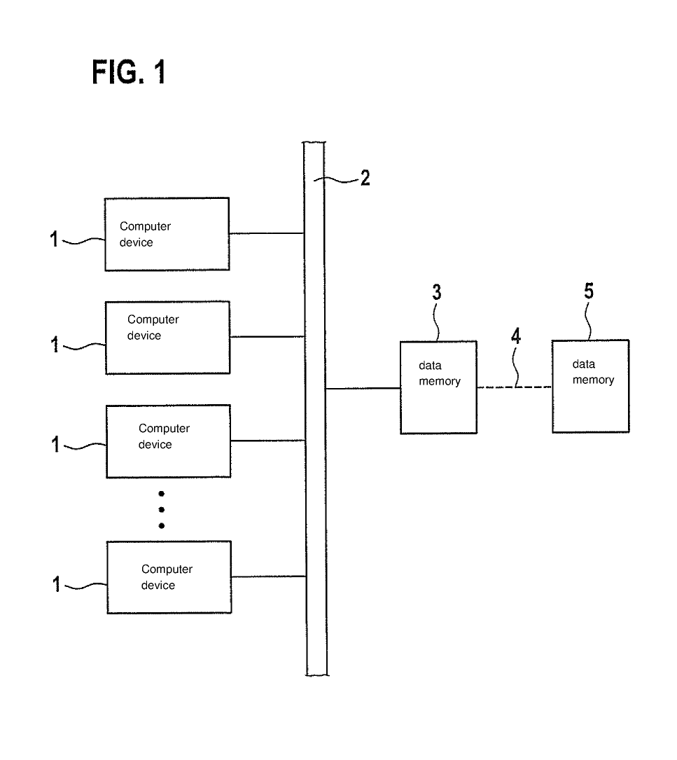

FIG. 1 shows computer devices 1 which, for example, are developed as control devices in motor vehicles. Via a communications system 2 which includes one or more bus system(s), these computer devices 1 are connected, for instance, to a data memory 3, which is realized in software or hardware, for example, and assumes the functions of what is known as a network attached storage. In the specific embodiment shown in FIG. 1, data memory 3 is connectable to a data memory 5 situated outside the vehicle, by way of a communications link 4, which preferably is developed as a mobile radio connection. Data memory 5 located outside the vehicle is able to be reached via the internet, which is referred to as cloud or as internal attached storage, for example. Data memory 5 can reach it via a gateway, not shown in FIG. 1, in order to transmit complete software images of individual control devices to the external data memory and to receive such from there.

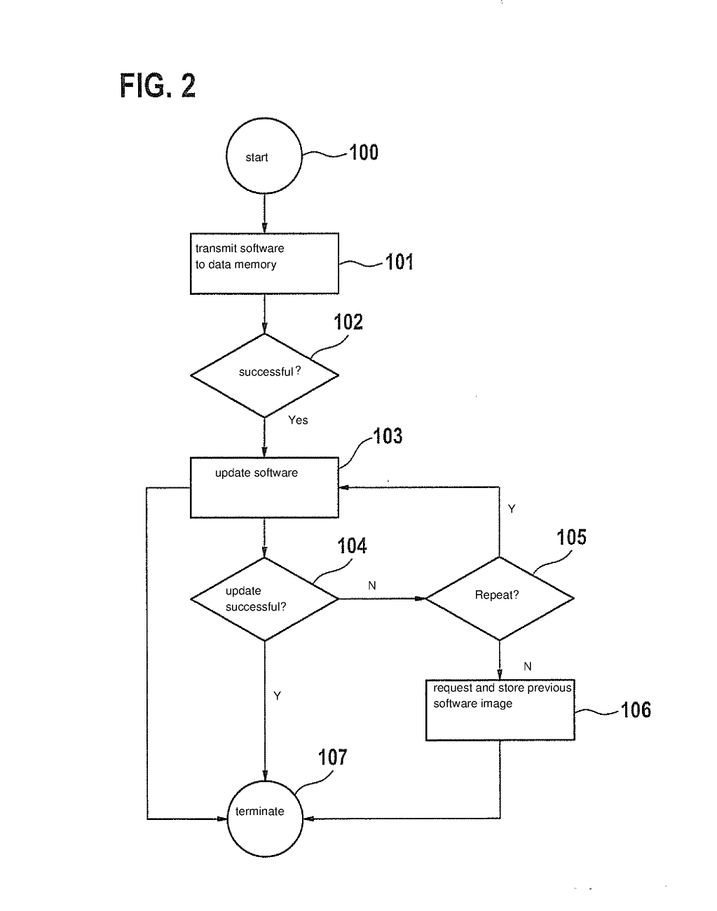

FIG. 2 shows a flow chart, which corresponds to one possible specific embodiment of the method of the present invention. The method starts in a step 100. In a step 101, the entire image of the software stored on computer device 1 is transmitted to data memory 3, which is situated inside the vehicle. It may be the case that the software image is also forwarded to an external data memory 5 in this step 101, which preferably can be reached via the internet.

In a step 102 it is checked whether the transmission and storing of the memory image has been successful. If this is not the case, the entire update method will be aborted according to the specific embodiment shown in FIG. 2.

In the event that—according to other possible specific embodiments—the prior readout of the control device software and the control device data is not possible, which may also be the case if the readout functionality is blocked, for instance, one or more of the following step(s) (not shown in FIG. 2) can be carried out as an alternative or in addition:
The update is carried out without prior backup, i.e., without prior safeguarding of the content of the control device, or
An attempt is made to download from a server of the manufacturer or another provider the stored software to be updated using a version number and/or a device number. If the update then fails during a later step, it is possible to update at least the original software again even though the possibly existing data are no longer restorable.

If the transmission and the storing of the software image in step 102 has been successful, then the software on computer device 1 is updated in a step 103 in the exemplary embodiment shown in FIG. 2. To do so, the updated version is transmitted, for instance via a mobile radio link or via a bus system or from a flash memory, to computer device 1, where it overwrites the existing software. In a step 104, it is then checked whether the update has been successful, that is to say, whether the entire updating process was run through completely, i.e., whether the updated software was transmitted in full and was stored on the computer device, for example. It may be provided to perform a test for this purpose, e.g., in the form of a new startup of computer device 1.

If the update was successful, the method is terminated in a step 107. In the other case, it is checked in a step 105 whether the updating process should be repeated. For instance, a counter may be provided for this purpose and also a limit value which indicates how many attempts are to be made. Furthermore, it is possible, to check why the update was not successful and to decide as a function of a possible reason whether another attempt would be useful. For example, if the data of the updated software are corrupted, then a new attempt would fail as well.

If a new updating attempt is made, branching to step 103 takes place. In the other case, the previously stored software image is requested from data memory 3 in a step 106 and stored on computer device 1. This makes computer device 1 operative again since it is in the same state as prior to the updating attempt.

In the event of a fault during the execution of the software update of a control device, the method of the present invention therefore makes it possible to keep a control device operative or to allow its renewed operation in that the previously existing software is able to be recopied again. This is advantageous because the software installed on a control device is often directly overwritten in a software update, so that the control device is no longer operative if an update is aborted on account of a fault. The reliability of the entire system thus is increased, and the entire process for making the original data available again is made easier at the same time in that no complicated new software installation and configuration is necessary. Instead, only the entire image of the original software together with the configuration data is retransmitted to the control device. This is particularly useful in updates that take place via a mobile radio network and in cases where the vehicle is not in a service facility or no skilled personnel is available.

Data memory 3 is situated inside the vehicle and set up in such a way that it can be reached by many, preferably all, control devices in the vehicle. The placement within the vehicle enhances the autarchy or availability of the overall system for restoring the previous state.

It may be particularly advantageous if the images of the software and the data of the control devices are synchronized with a memory unit that is situated outside the vehicle and in which a complete history of the updates is stored, which may perhaps be impossible due to the limited storage capacity of data memory 3 situated within the vehicle.

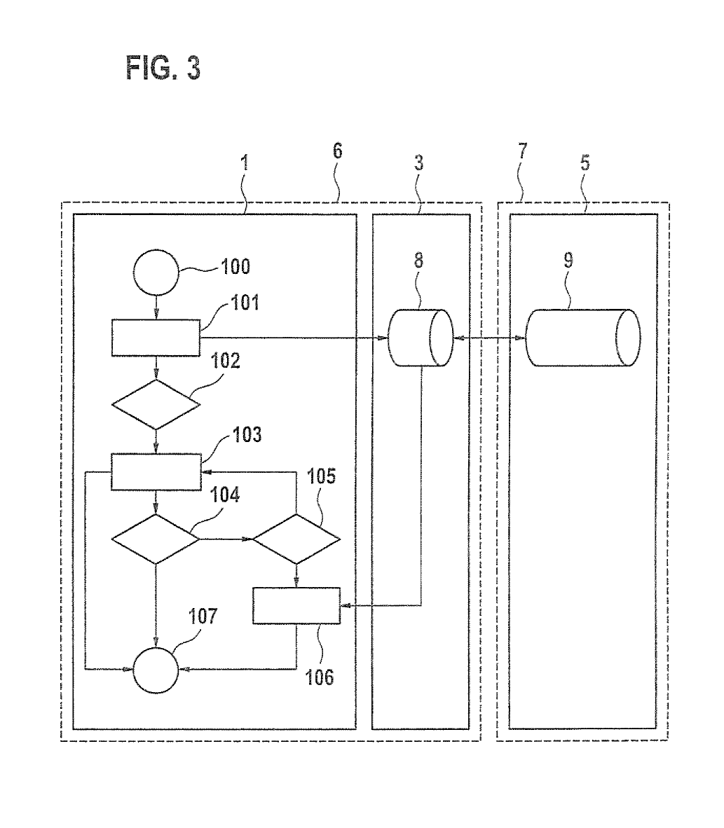

FIG. 3 shows the manner in which the flow chart from FIG. 2 is able to be integrated into the individual components of the entire system according to one possible specific embodiment. An area sketched by a dashed line denotes a transportation device 6, which in particular may be a motor vehicle, in which a computer device 1 is situated, such as a control device, for instance. A data memory 3 is also situated inside transportation device 6.

An area outside the transportation device or vehicle, which may be what is known as a backend 7, is shown in FIG. 3. A data memory 5, which is realized as so-called cloud, is available in backend 7.

As described earlier, an image of the software of computer device 1 is transmitted to data memory 3 in step 101, where it is stored in a memory area 8. It may be advantageous to transmit the image of the software also to external data memory 5, for instance via a mobile radio communications link 4, where it is stored in a memory area 9. This may be advantageous in particular when data memory 3 has insufficient memory for the complete storing of the software image of computer device 1 or further computer devices, and for ensuring that the original image may be called up again even if data memory 3 is malfunctioning. The transmission to external data memory 5 preferably takes place only when the data connection to data memory 5 is operating in a reliable manner, which may possibly be checked or ensured beforehand in case of a mobile radio communications link. As an alternative or in addition, it may be the case here that at least the control device software is stored in data memory 3 and the data of the control device or of computer device 1 are transmitted on external data memory 5, so that the original software is able to be recovered again without fail.

If the update was not successful, the image of the software is reinstalled on computer device 1 in step 106. To do so, it is requested from data memory 3 and transmitted from there to computer device 1. If it is not available in data memory 3, it is requested from external memory 5 and finally transmitted to computer device 1.

The exemplary embodiment shown in FIG. 3 furthermore offers the advantage that enough memory space is able to be provided on external memory 5 that all software images of all computer devices 1 are able to be stored in the vehicle on a permanent basis or for a longer period of time.

What is claimed is:

1. A method for updating software of a control device situated in a motor vehicle, comprising:
storing, prior to starting the update, an image of the software on the control device in a data memory which is able to be connected to the control device via a communications system;
loading an updated software onto the control device;
checking whether the update has been successful; and
transmitting at least a portion of the image stored in the data memory to the control device and restoring the image if the update is not successful.

2. The method as recited in claim 1, wherein the software includes data that are at least one of created and collected, while the computer device is in operation.

3. The method as recited in claim 1, wherein if the update was not successful, at least one further attempt is made to load the updated software onto the computer device.

4. The method as recited in claim 1, wherein the image of the software on the control device is transmitted via a wireless connection to a data memory situated outside the motor vehicle.

5. The method as recited in claim 4, wherein the image of the data memory situated outside the motor-vehicle is transmitted to the control device if the software update was not successful.

6. The method as recited in claims 5, wherein a history of implemented updates together with images transmitted prior to the individual update is stored in the data memory situated outside the motor vehicle.

7. The method as recited in claim 1, wherein a plurality of control devices that are able to be connected to the data memory via at least one communication system is situated inside the motor vehicle, and an update of the control devices is performed.

8. A device for updating software on at least one computer device in a transportation device, the device comprising:
a data memory which is connectable to the computer device via a communications system;
an element to create an image of a software stored on the at least one computer device;
an element to transmit the image to the data memory;
an element to load an updated software onto the at least one computer device;
a test element to check whether the update has been successful; and
a transmission element to transmit the image stored in the data memory to the at least one computer device and to restore the image if the software update was not successful.

9. A control device in a motor vehicle, the control device configured to:
store, prior to starting the update, an image of the software on the control device in a data memory which is able to be connected to the control device via a communications system;
load an updated software onto the control device;
check whether the update has been successful; and
transmit at least a portion of the image stored in the data memory to the control device and restored the image if the update is not successful.

10. A computer readable storage medium storing a computer program, the program when executed by a computer device, causing the computer device to perform a method for updating software of a control device situated in a motor vehicle, the method comprising:
storing, prior to starting the update, an image of the software on the control device in a data memory which is able to be connected to the control device via a communications system;
loading an updated software onto the control device;
checking whether the update has been successful; and
transmitting at least a portion of the image stored in the data memory to the control device and restored the image if the update is not successful.
